(19) United States
(12) Patent Application Publication
(10) Pub. No.: US 2019/0376868 A1
(43) Pub. Date: Dec. 12, 2019

(54) DETECTING A FLUID LEAK IN A VACUUM CHAMBER

(71) Applicant: Waters Technologies Corporation, Milford, MA (US)

(72) Inventors: Kurt D. Joudrey, Chelmsford, MA (US); Bennett Bowers, Boston, MA (US)

(21) Appl. No.: 16/436,113

(22) Filed: Jun. 10, 2019

Related U.S. Application Data
(60) Provisional application No. 62/683,106, filed on Jun. 11, 2018.

(51) Int. Cl. G01M 3/00; G01N 30/62

(52) U.S. Cl. CPC G01M 3/002; G01N 2030/027; G01N 30/62

(57) ABSTRACT

A method for detecting a fluid leak in a vacuum chamber of a degasser is provided. The method includes measuring a temperature of the vacuum chamber with a temperature sensing device, wherein a temperature drop of the vacuum chamber indicates the fluid leak within the vacuum chamber. An associated degasser and further methods are also provided.

### CROSS-REFERENCE TO RELATED APPLICATIONS

This application claims priority to and the benefit of U.S. Provisional Application No. 62/683,106, filed Jun. 11, 2018, and entitled, “Detecting a Fluid Leak in a Vacuum Chamber.”

### FIELD OF TECHNOLOGY

following relates to detecting a fluid leak in a vacuum chamber, and more specifically to embodiments of a method for detecting a fluid leak in a vacuum chamber of a degasser used in a liquid chromatography system.

### BACKGROUND

Liquid chromatography is a technique in analytic chemistry where distinct components of a mixture are identified by separating the individual components by passing the mixture through an adsorbent medium using fluid flow so that the components elute at different rates. Liquid chromatography systems are typically comprised of a solvent reservoir, one or more degassers, a solvent delivery pump, an autosampler, a column, and a detector. The solvent delivery pump pumps mobile phase fluid through the system, the autosampler introduces the sample to be analyzed to the analytic flow path, the column contains the adsorbent packing material used to effect separation, and the detector detects the separated components as they elute out of the column.

Degassers serve the purpose of removing dissolved gas from the mobile phase, which improves performance and reliability of the solvent delivery pump and the detector. Many degassers contain several vacuum chambers connected to a single vacuum source. Occasionally, a leak may occur within one of the vacuum chambers of the degasser, causing problems with accuracy and reliability of the liquid chromatography system. There is no convenient, cost effective, and reliable way of detecting which vacuum chamber of the degasser may have a leak. Currently, if a leak occurs within in one of the vacuum chambers, a field service engineer will replace all of the vacuum components, dry the system out and replace the pump, or replace all of the vacuum chambers. In some instance, the field service engineer may discover the leaky vacuum chamber, but only during a servicing operation in which liquid phase solvent is still located within the failed vacuum chamber.

Thus, a need exists for a method of detecting a leak within a vacuum chamber of a degasser unit.

### SUMMARY

A first aspect relates generally to a method for detecting a fluid leak in a vacuum chamber, the method comprising measuring a temperature of the vacuum chamber with a temperature sensing device, wherein a temperature drop of the vacuum chamber indicates the fluid leak within the vacuum chamber.

A second aspect relates generally to a method for identifying a vacuum chamber having a leak out of a plurality of vacuum chambers of a degasser within a liquid chromatography system, each vacuum chamber being connected to a same vacuum source, comprising: measuring a temperature of a vacuum chamber wall of each vacuum chamber of the plurality of vacuum chambers using a plurality of temperature sensing devices, detecting a change in temperature in the vacuum chamber wall of a single vacuum chamber of the plurality of vacuum chambers, and identifying the single vacuum chamber with the temperature change in the vacuum chamber wall as the vacuum chamber having a leak.

A third aspect relates generally to a degasser of a liquid chromatography system, comprising: a vacuum chamber having an interior region, the interior region being under a vacuum, an inlet connected to the vacuum chamber, the inlet configured to receive a flow of a liquid phase solvent from a solvent reservoir of the liquid chromatography system, an outlet connected to the vacuum chamber, the outlet configured to output a degassed flow of liquid solvent, and a temperature sensing device for measuring a temperature of the vacuum chamber, wherein, when the temperature sensing device detects a drop in temperature of the vacuum chamber, the liquid phase solvent is leaking into the interior region of the vacuum chamber.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a schematic view of a degasser having a plurality of vacuum chambers, in accordance with embodiments of the present invention;

FIG. 2 depicts a cross-sectional view of a vacuum chamber having one or more temperature sensing devices, in accordance with embodiments of the present invention;

FIG. 3 depicts a perspective view of the vacuum chamber having one or more temperature sensing devices, in accordance with embodiments of the present invention;

FIG. 4 depicts a cross-sectional view of the vacuum chamber having a temperature sensing device attached to a dedicated measuring spot, in accordance with embodiments of the present invention;

FIG. 5 depicts a cross-sectional view of the vacuum chamber having a temperature sensing device molded into wall of the vacuum chamber, in accordance with embodiments of the present invention;

FIG. 6 depicts a perspective view of the vacuum chamber and a non-contact sensor used to measure a temperature of the vacuum chamber, in accordance with embodiments of the present invention;

FIG. 7 depicts a graph showing a correlation between a temperature drop of a vacuum chamber and a leak initiated in the vacuum chamber, in accordance with embodiments of the present invention;

FIG. 8 depicts a graph showing a correlation between a pressure drop of a vacuum chamber and when a leak in the vacuum chamber is stopped, in accordance with embodiments of the present invention; and

FIG. 9 depicts a schematic diagram of a liquid chromatography system, in accordance with embodiments of the present invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

A fluid leak in a vacuum chamber of a degasser can be problematic for accurate and reliable results of a liquid chromatography applications. Leaks may occasionally occur within the vacuum chamber, but it can be difficult to determine which vacuum chamber is the one that is leaking. As a result, all vacuum chambers are generally replaced, which can be costly and work intensive. Detecting which vacuum chamber has a leak would thus save valuable resources, repair time, costs, and the like, as well as prompting a stop in the run to avoid bad or inaccurate data. Embodiments of the present invention relate to a method for detecting a leak in a vacuum chamber of a degasser. For instance, a leak can be detected by measuring a temperature of the vacuum degasser chambers of the degasser. A temperature of the vacuum chamber drops as a solvent (e.g. mobile phase) evaporates within the vacuum chamber, so monitoring the individual vacuum chambers for a temperature drop can be used to identify if there is a leak and which vacuum chamber has the leak. In some embodiments, a temperature of the degasser chamber wall may be measured to identify if there is fluid in the chamber or a fluid leaking into the vacuum chamber. As the fluid (e.g. liquid phase solvent) evaporates, the fluid will cool the vacuum chamber. The temperature change depends on the fluid volume and properties as well as the vacuum chamber volume and material properties. Using this methodology, a field service engineer may identify if a chamber is leaking, and which vacuum chamber is leaking out of a plurality of vacuum chambers.

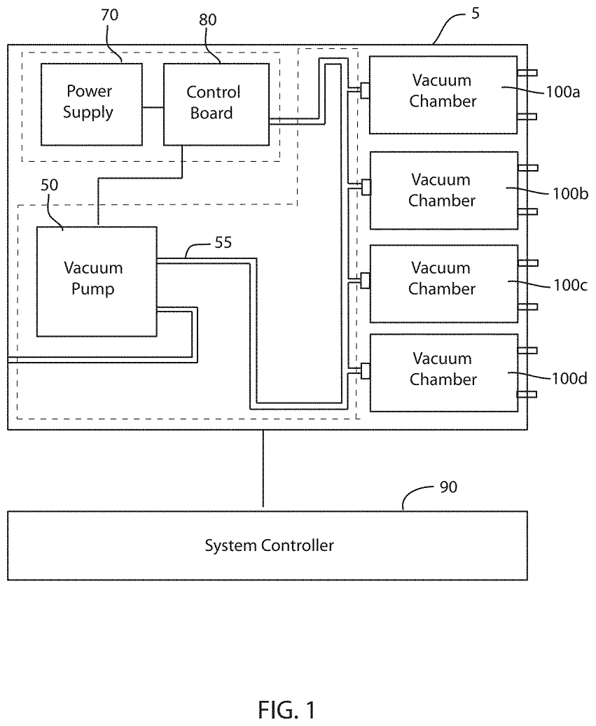

Referring now to the drawings, FIG. 1 depicts a schematic view of a degasser system 5 having a plurality of vacuum chambers 100a, 100b, 100c, 100d, in accordance with embodiments of the present invention. Embodiments of the degasser system 5 may be a degasser, a degasser unit, a degassing component, and the like. In an exemplary embodiment, the degasser system 5 may be a degasser used in liquid chromatography applications for removing dissolved gases from a mobile phase. The degasser system 5 may be positioned between a solvent reservoir and a solvent pump in a liquid chromatography system. Embodiments of the degasser system 5 may be a tube degasser, a membrane degasser, or any type of degasser that is designed to remove dissolved gas from a liquid under a vacuum pressure. Embodiments of the degasser system 5 may be electrically coupled to a system controller 90, which may control one or more operations of the degasser system 5, including an error monitoring module, as well as other system components of a liquid chromatography system. Embodiments of the degasser system 5 may have an eluent system, a vacuum system, and an electrical and control system. The eluent system may refer to components within the vacuum chambers 100a, 100b, 100c, 100d that receive the eluent flow path and remove the dissolved gases from the eluent flow path. The vacuum system may provide a vacuum at a preset level to the connected vacuum chambers 100a, 100b, 100c, 100d. The vacuum system of the degasser system 5 may include a vacuum pump 50, a vacuum sensor (not shown) and the vacuum chambers 100a, 100b, 100c, 100d. In an exemplary embodiment, the vacuum pump 50 may be an electrical two-speed stepper motor pump that creates a vacuum in the vacuum chamber 100a, 100b, 100c, 100d. The vacuum pump 50 may be fluidically connected to the vacuum chambers 100a, 100b, 100c, 100d via vacuum line 55. Embodiments of the vacuum sensor may be a sensor on a control board 80 that monitors the vacuum in the system. For example, the vacuum sensor may signal the control board 80 when the vacuum is below a preset level. Embodiments of the vacuum chambers 100a, 100b, 100c, 100d, as part of a vacuum system of the degasser system 5, may be connected to the vacuum pump 55, and may contain a gas-permeable eluent channel, wherein gases may be removed from the eluent in the chambers 100a, 100b, 100c, 100d. Moreover, the electrical and control system of the degasser system 5 may include a power supply 70, which may convert AC voltage to DC voltages that are used by the control board 80 and the vacuum pump 50. The electrical and control system may also include a control board 80, which contains circuits that may monitor the vacuum, turn on the vacuum pump 50 and control a speed of the vacuum pump 50, and control an LED panel of the degasser system 5.

As shown in FIG. 1, embodiments of the degasser system 5 may include a plurality of vacuum chamber 100a, 100b, 100c, 100d. While four vacuum chambers are shown, embodiments of the degasser system 5 may include less than four vacuum chambers or more than four vacuum chambers. If one of the vacuum chambers 100a, 100b, 100c, 100d has a leak, it can affect the entire system. Identifying or otherwise diagnosing which of the vacuum chambers 100a, 100b, 100c, 100d is leaking avoids a need to replace all of the vacuum chambers or repair/replace other components of the degasser system 5 that were not the source of the problem. Identifying a vacuum chamber having a leak out of a plurality of vacuum chambers within a degasser system 5 of liquid chromatography system may be accomplished by measuring a temperature of each vacuum chamber of a plurality of degasser chambers using a plurality of temperature sensing devices (e.g. temperature sensor) and detecting a change in temperature in the vacuum chamber of one of the vacuum chambers of the plurality of degasser chambers. The degasser chamber with the temperature change in the degasser chamber may be identified as the faulty vacuum chamber.

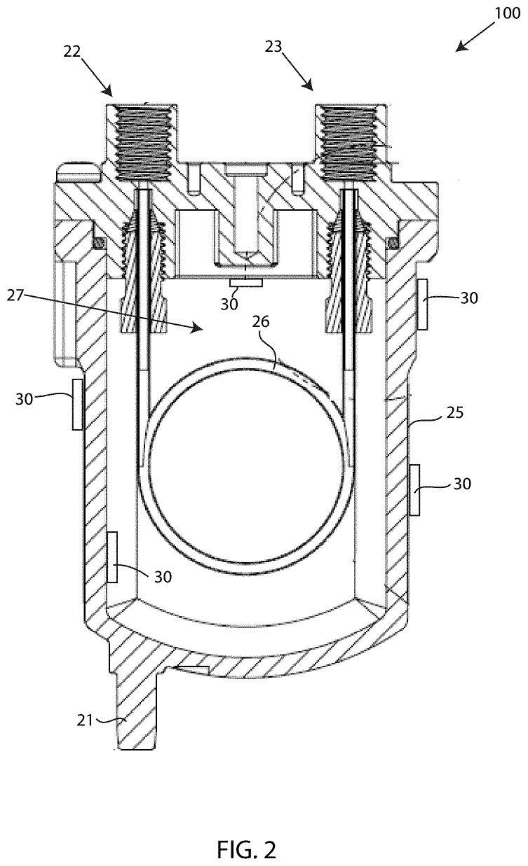

Referring now to FIG. 2, which depicts a cross-sectional view of a vacuum chamber 100a, 100b, 100c, 100d having one or more temperature sensing devices 30, in accordance with embodiments of the present invention. Embodiments of the vacuum chambers 100a, 100b, 100c, 100d may be described with reference to a single vacuum chamber 100, wherein each vacuum chamber within the degasser system 5 may share the same or substantially the same structure and function as the other vacuum chambers within the degasser system 5. Embodiments of the vacuum chamber 100 may be a vacuum chamber, a degasser chamber, a degassing chamber, a chamber, a vacuum container, an eluent degassing chamber, an eluent degasser, a mobile phase degassing unit, a vacuum unit, and the like. Embodiments of the vacuum chamber 100 may include a vacuum connection 21 that may be configured to connect with vacuum line 55 of the vacuum pump 55. In an exemplary embodiment, each vacuum chamber 100 located within the degasser system 5 may be connected to a single vacuum pump 50. In other embodiments, a first plurality of vacuum chambers 100 may be connected to a first pump source, while a second plurality of vacuum chambers 100 may be connected to a second pump source. Further, embodiments of the vacuum chamber 100 may also include an inlet 22 and an outlet 23. The inlet 22 may be configured to receive an eluent, such as a mobile phase, while the outlet 23 may be configured to allow passage of degassed eluent out of the vacuum chamber 100.

Moreover, embodiments of the vacuum chamber 100 may include an interior region 27. The interior region 27 may be a region, a space, a void, an opening, a cavity, an enclosed volume, and the like, within the vacuum chamber 100. The interior region 27 may be enclosed, housed, or otherwise defined by a wall 25 of the vacuum chamber 100. Embodiments of the wall 25 may be an exterior wall of the vacuum chamber 100. The wall 25 may form a housing or body portion of the vacuum chamber 100. Embodiments of the vacuum chamber 100 may also include an eluent channel 26 disposed within the interior region 27 of the vacuum chamber 100. Embodiments of the eluent channel 26 may be a gas-permeable membrane channel that carries the mobile phase solvent through the interior region 27 of the vacuum chamber 100. Embodiments of the eluent channel may be a tube, a membrane, a channel, a pathway, and the like, configured to allow dissolved gas molecules from the mobile phase to diffuse through the membrane into the interior region 27 of the vacuum chamber 100 and then into the vacuum pump 50. In an exemplary embodiment, the eluent channel 26 may be a tubular, fluorocarbon polymer membrane. In other embodiments, the eluent channel 26 may have different shapes, configurations, and materials. For example, the eluent channel 26 may be a multi-lumen channel comprised of Teflon.

In some cases, leaks may occur within the vacuum chamber 100, wherein a liquid phase solvent enters the interior region 27 of the vacuum chamber 100. For example, the eluent channel 26 may rupture, or a pinhole tear may occur in the eluent channel 26, allowing liquid phase solvent to leave the eluent channel 26 and enter the interior region 27 of the vacuum chamber 100. Liquid from the eluent channel 26 may also escape into the interior region 27 through loose connection fittings used to secure the eluent channel 26 to the inlet 22 and outlet 23. When the liquid phase of the solvent enters the interior region 27 of the vacuum chamber 100, the solvent is vaporized by the vacuum within the vacuum chamber 100, which pulls heat from the interior region 27 of the vacuum chamber 100, thereby lowering the temperature of the vacuum chamber 100. In other words, the vaporization of the liquid phase leaking inside the vacuum chamber 100 causes a temperature of the vacuum chamber 100 to drop. Detecting the temperature drop of the vacuum chamber 100 may allow for detection of the leak within the particular vacuum chamber 100. One or more temperature sensing devices 30 may be used to measure the temperature drop of the vacuum chamber 100. Embodiments of the temperature sensing devices 30 may be a temperature sensor configured to measure an absolute temperature of the vacuum chamber 100 (e.g. a temperature of the wall 25 of a temperature of the interior region 27), or may be one or more temperature sensors configured to measure a temperature differential between a plurality of vacuum chambers 100a, 100b, 100c, 100d within the degasser system 5, or may be a temperature differential between a reference temperature and a temperature sensor 100. A plurality of temperature sensors may also be used to measure a temperature differential between the vacuum chamber 100 and an environment surrounding the vacuum chamber 100. Embodiments of the temperature measuring device 30 may need to be sensitive enough to detect a temperature change within the vacuum chamber 100, or the vacuum chamber 100 may be designed to allow a large enough temperature change to be measured.

Referring still to FIG. 2, embodiments of the vacuum chamber 100 may include one or more temperature sensing devices 30. The temperature sensing devices 30 may be coupled, attached, mounted to, fastened, adhered, or otherwise placed into contact with the wall 25 of the vacuum chamber 100 to measure a temperature of the vacuum chamber 100 (i.e. a measured temperature drop of the vacuum chamber 100 may indicate a leak within the chamber 100). For instance, a temperature drop of the vacuum chamber 100 that is inconsistent with an ambient temperature change may signal a leak within the vacuum chamber 100. In an exemplary embodiment, a temperature sensing device 30 may be coupled to the wall 25 to measure a temperature of the wall 25 of the vacuum chamber 100. The temperature of the wall 25 may be the same or substantially the same as a temperature of the entire vacuum chamber 100 or an interior region 27 of the vacuum chamber 100. Thus, the temperature of the wall 25 of the vacuum chamber 100 may be measured by the temperature sensing device to detect whether a leak has occurred within the vacuum chamber 100. For example, if the temperature sensing device 30 measures a temperature drop of the wall 25 of the vacuum chamber 100, a signal may be sent to an error monitoring module of the system controller 90. The measured temperature drop that may signal a leak may vary depending on the design of the chamber (e.g. volume of interior region, size of chamber, the size of the leak, etc.) In an exemplary embodiment, a temperature drop of 0.5° C. or more may be a significant enough temperature drop to determine that there is a leak in the vacuum chamber 100. The detected temperature drop may be compared to other temperature sensors placed on the vacuum chamber or otherwise within a shared environment. For instance, if an environmental temperature were to drop, then all the sensors may drop, though possibly not at the same rate as a leak in the chamber would cause a temperature change. Therefore, the system could potentially use the temperature drop of all the chambers, and the environment, to identify an environmental change rather than a vacuum leak. Other techniques may be used to detect and confirm a temperature drop of the vacuum chamber 100, such as correlating the temperature drop to a change in the vacuum pressure.

In other embodiments, if the temperature sensing device 30 measures that a temperature of the wall 25 of the vacuum chamber 100 drops below a certain temperature (e.g. 0.5° C. below normal/expected temperate), a signal may be sent to an error monitoring module of the system controller 90. If the temperature sensing device 30 measures a temperature drop of the wall 25 of the vacuum chamber 100 exceeding a certain percentage from an acceptable or preset temperature, then a signal may be sent to the error monitoring module of the system controller 90. Other error monitoring means may be employed to alert a user/operator that a temperature drop has occurred.

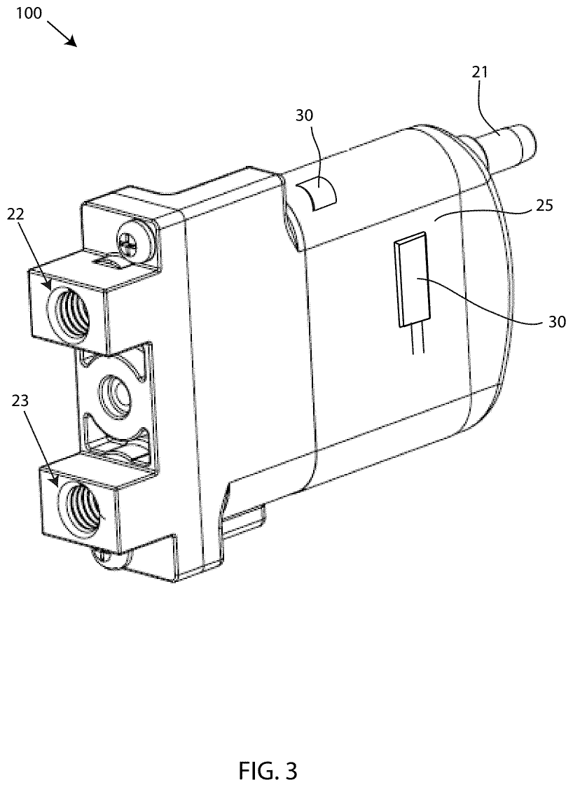

In an exemplary embodiment, a single temperature sensing device 30 may be placed on the wall 25 of the vacuum chamber 100 to measure the temperature of the vacuum chamber 100 during operation of the degasser system 5. The location on the wall 25 may vary according to a design, shape, configuration, or constraints around the vacuum chamber 100 when operable assembled within the degasser system 5. In one embodiment, a single temperature sensing device 30 may be placed on the wall 25 along a right side of the vacuum chamber 100. In another embodiment, a single temperature sensor 30 may be placed along a left side of the vacuum chamber 100. In another embodiment, a single temperature sensing device 30 may be placed along the side of the vacuum chamber 100 proximate the inlet 22 or the outlet 23. Various sensor placements may be utilized to measure the temperature of the vacuum chamber 100 to detect a leak. As shown in FIG. 3, embodiments of a temperature sensing device 30 may be placed on a top of the vacuum chamber 100. A temperature sensing device 30 may also be placed on a bottom of the vacuum chamber 100. Furthermore, more than one temperature sensing device 30 may be placed on the wall 25 or general housing structure of the vacuum chamber 100. The temperature sensing devices 30 being placed at various locations may communicate with each other over a network to confirm measurements, or obtain temperature measurements at precise locations of the vacuum chamber 100. For instance, a temperature change may be detected by a first temperature sensing device 30 placed proximate the front side of the vacuum chamber 100, where a source of the leak is located within the interior region 27, but no temperature change may be detected by a second temperature sensing device 30 placed at a back portion of the opposing side of the vacuum chamber 100. In this scenario, if there would have only been a single temperature sensing device 30, then the temperature change, and potential leak, would not be discovered until the temperature change was detectible by the second temperature sensing device 30. Conversely, if no leak occurred, and the first temperature sensing device 30 detected a temperature change, the system controller 90 may check temperature readings from the second temperature sensing device 30, and potentially others, to confirm whether or not the first temperature sensing device 30 was measuring an accurate temperature.

In further embodiments, on or more temperature sensing devices 30 may be placed within the interior region 27 of the vacuum chamber to measure, obtain, detect, monitor, etc. a temperature of the vacuum chamber 100. For instance, one or more temperature sensing devices 30 may be disposed within the interior region 27 (e.g. attached to inner surface of wall 25) to measure a temperature of the interior region 27 where the vaporization of the solvent may initially take place to reduce the temperature within the interior region 30. The temperature sensing device 30 placed within the interior region 27 may also communicate with the temperature sensing device 30 located external to the interior region 27. Moreover, embodiments of the temperature sensing devices 30 may be electrically or communicatively connected to the system controller 90, via lead wires, signals sent over a network, etc. In addition, the temperature sensing device(s) 30 may communicate wirelessly with the system controller 90.

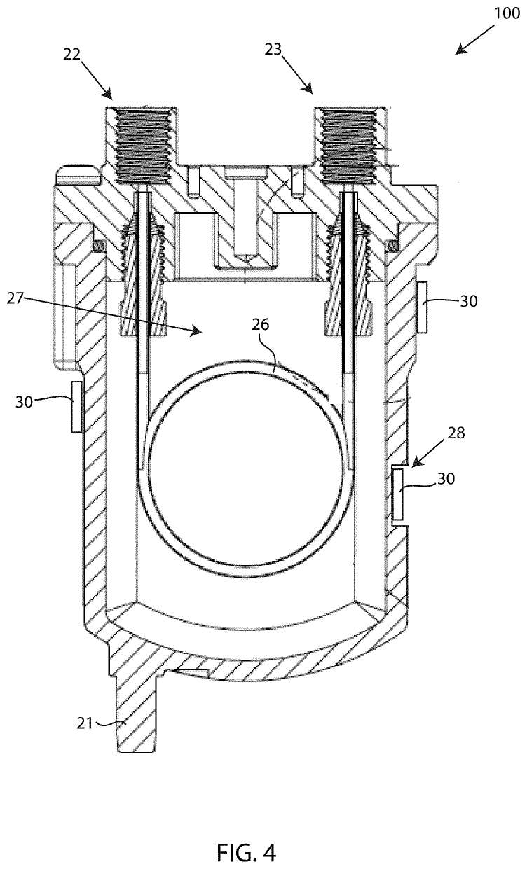

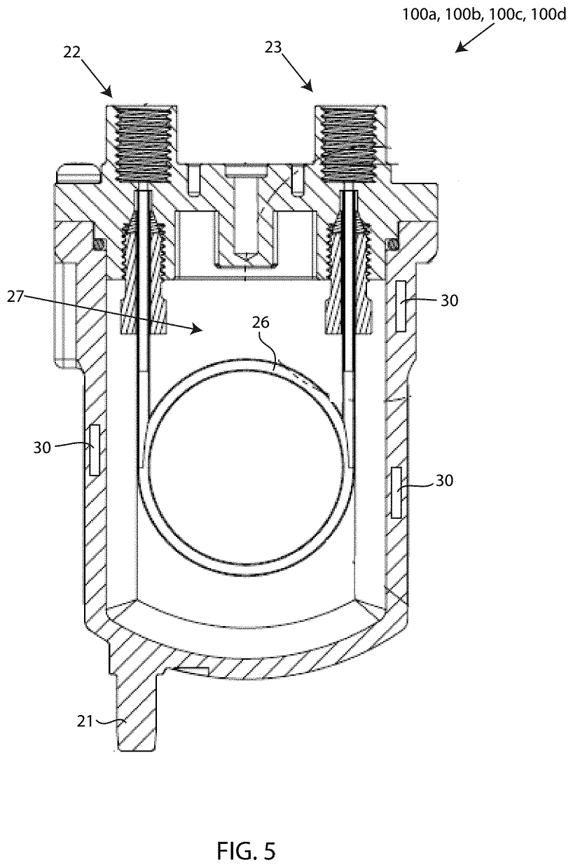

With continued reference to the drawings, FIG. 4 depicts a cross-sectional view of the vacuum chamber having a temperature sensing device attached to a dedicated measuring spot 28, in accordance with embodiments of the present invention. For example, a temperature sensing device 30 may be attached to the wall 25 of the vacuum chamber 100 at a dedicated measuring spot 28 of the wall that may be more sensitive to heat transfer from within the interior region 27 of the vacuum chamber 100 than a rest of the wall 25 of the vacuum chamber 100. For instance, a dedicated measuring spot 28 may be a section or location along the wall 25 of the vacuum chamber 100 having a reduced wall thickness than a rest of the wall 25, for receiving the temperature device 30. Embodiments of the dedicated measuring spot 28 may be created by removing, notching, or otherwise modifying a section of the wall 25 to create a cavity or recess within the wall 25. The reduced thickness of the wall 25 at the dedicated measuring spot 28 may result in a shorter path length for heat conduction through the wall 25 of the vacuum chamber 100. Additionally, the dedicated measuring spot 28 may permit the temperature sensing device 30 to be offset or at least flush with the exterior surface of the wall 30, saving space within the degasser 30 and reducing a likelihood of damage. FIG. 5 depicts another embodiment of temperature sensing placement, in accordance with embodiments of the present invention. In particular, FIG. 5 depicts a cross-sectional view of the vacuum chamber 100 having a temperature sensing device(s) 30 molded into wall 25 of the vacuum chamber 100, in accordance with embodiments of the present invention. With the molded design, the temperature sensing device is less likely to be damaged or disengaged from a contact position with the wall 25 or surface of the vacuum chamber 100. The molded placement may also reduce a conduction path length, similar to the dedicated measuring spot 28 described above. In an exemplary embodiment, during construction of the vacuum chamber 100, one or more temperature sensing devices 30 may be placed into the mold of the vacuum chamber 100, so that the temperature sensing device is molded within or otherwise integrated within the wall 25 of the vacuum chamber 100.

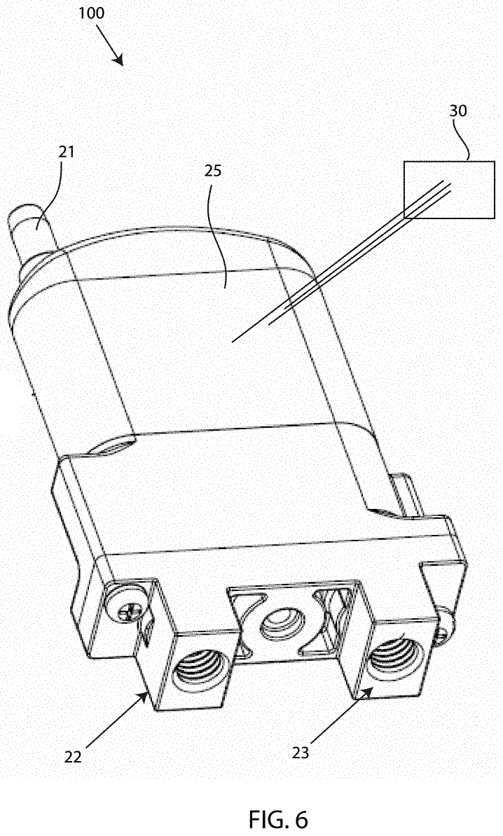

In exemplary embodiments of the present invention, the temperature sensing device 30 may be a contact sensor. For example, the temperature sensing device 30 may be in physical, mechanical, direct contact or engagement with a surface of the vacuum chamber 100 for measuring the temperature of the vacuum chamber 100. However, in alternative embodiment, the temperature sensing device 30 may be a non-contact sensor. FIG. 6 depicts a perspective view of the vacuum chamber 100 and a non-contact sensor 30 used to measure a temperature of the vacuum chamber, in accordance with embodiments of the present invention. Embodiments of the non-contact sensor may measure a temperature of the vacuum chamber 100 without making direct, physical, mechanical contact with a surface of the vacuum chamber 100. In an exemplary embodiment, the non-contact sensor may be an infrared temperature sensor, which may radiate infrared light towards the surface of the vacuum chamber 100 to obtain an absolute temperature of the vacuum chamber 100. The non-contact sensor may be arranged or otherwise mounted to surface of the interior of the degasser system 5 (e.g. an inner surface of the degasser housing) or to a nearby component within the degasser system 5 (e.g. a static component or structural support member of the degasser system 5). The non-contact sensor may be in communication with the system controller 90 as described above. In other embodiment, the vacuum chamber 100 may include a window, such as a transparent section of the vacuum chamber wall 25, to facilitate a non-contact reading of a temperature of the internal region 27 of the vacuum chamber 100.

Accordingly, a fluid leak in a vacuum chamber 100 may be detected by measuring a temperature of the vacuum chamber 100 with a temperature sensing device 30 because a temperature change (e.g. drop in temperature) of the vacuum chamber 100 indicates a fluid leak within the vacuum chamber 100. As the fluid (e.g. liquid phase of solvent) leaks into the vacuum chamber 100 as a result of a damaged eluent channel 26, loose connection fitting, or other reason, the fluid is vaporized causing a reduction in temperature because the act of vaporizing the liquid solvent pulls heat from the interior region 27 of the vacuum chamber 100, thereby lowering the temperature of the vacuum chamber 100. By coupling one or more temperature sensing devices 30 to each vacuum chamber 100a, 100b, 100c, 100d within the degasser system 5 and measuring the temperature of each vacuum chamber 100a, 100b, 100c, 100d individually, the fault/leaky vacuum chamber can be identified and replaced without needing to replace all of the vacuum chambers of the degasser system 5.

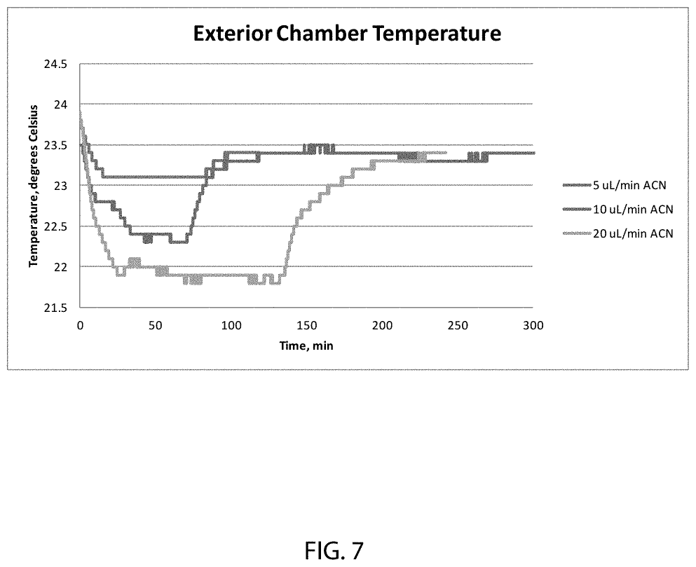

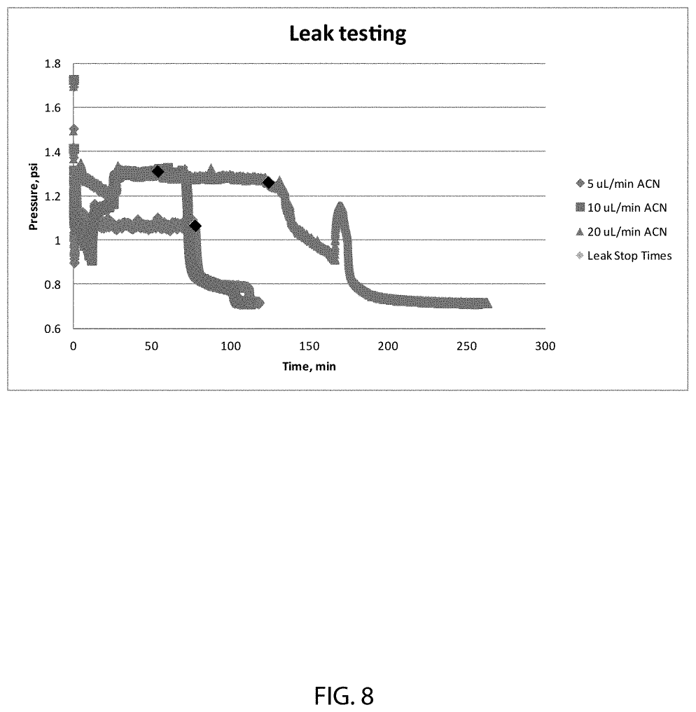

Turning now to FIG. 7, which depicts a graph showing a correlation between a temperature drop of a vacuum chamber and a leak initiated in the vacuum chamber, in accordance with embodiments of the present invention. Three different mobile phase flow rates (5 μl/min ACN, 10 μl/min ACN, and 20 μl/min ACN) were passed through the vacuum chamber 100 for degassing (e.g. controlled leaks into the vacuum chamber 100). A leak in the vacuum chamber 100 was initiated for all three mobile phase flows at the outset (e.g. approximately 0 minutes), and as can be seen in FIG. 7, there is a clear change in temperature at a point when the leak is initiated, and then the temperature recovers when the fluid has completely boiled off. This drop in temperature can be measured by the temperature sensing device 30 to detect when a leak occurs, and also which vacuum chamber is leaking, based on which temperature sensing device 300 is reporting the temperature change. FIG. 8 depicts a graph showing a correlation between a pressure drop of a vacuum chamber and when a leak in the vacuum chamber is stopped, in accordance with embodiments of the present invention. Three different mobile phase flow rates (5 μl/min ACN, 10 μl/min ACN, and 20 μl/min ACN) were passed through the vacuum chamber 100 for degassing (eg: controlled leaks into the vacuum chamber 100). A leak in the vacuum chamber 100 was introduced into the vacuum system while the vacuum system was pumping down, and then the leak was stopped (marked by diamond shapes in FIG. 8) at varying points in time for the three mobile phase flows. As can be seen, the pressure drops within the vacuum chamber 100 starting from when the leak is stopped. Combining FIGS. 7 and 8, the pressure data shows that when there is a leak (e.g. cannot get to low pressure), the temperature is low. Then when the leak stops the pressure rises, as does the temperature, because the solvent is boiled off.

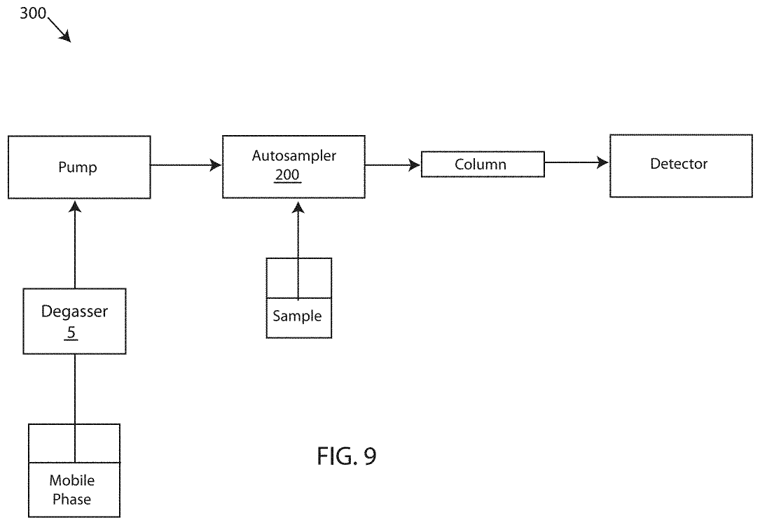

FIG. 9 depicts a schematic diagram of a liquid chromatography system 300, in accordance with embodiments of the present invention. Embodiments of a liquid chromatography system 300 may include a mobile phase, such as a solvent reservoir/source, a degasser system 5, one or more pumps, an autosampler in fluid communication with the sample, a column, and a detector, as known to those skilled in the art of liquid chromatography.

Referring now to FIGS. 1-9, a method for detecting a fluid leak in a vacuum chamber may include measuring a temperature of the vacuum chamber 100 with a temperature sensing device 30, wherein a temperature drop of the vacuum chamber 100 indicates the fluid leak within the vacuum chamber 100. Further, a method for identifying a vacuum chamber 100 having a leak out of a plurality of vacuum chambers 100a, 100b, 100c, 100d of a degasser system 5 within a liquid chromatography system 300, each vacuum chamber 100a, 100b, 100c, 100d being connected to a same vacuum source 50 may include measuring a temperature of a vacuum chamber wall 25 of each vacuum chamber 100a, 100b, 100c, 100d of the plurality of vacuum chambers 100a, 100b, 100c, 100d using a plurality of temperature sensing devices 30, detecting a change in temperature in the vacuum chamber wall 25 of a single vacuum chamber 100a of the plurality of vacuum chambers 100a, 100b, 100c, 100d, and identifying the single vacuum chamber 100a with the temperature change in the vacuum chamber wall 25 as the vacuum chamber 100a having a leak. Embodiments of a degasser system 5 of a liquid chromatography system 300 may include a vacuum chamber 100 having an interior region 27, the interior region 27 being under a vacuum from a vacuum source 50, an inlet 22 connected to the vacuum chamber 100, the inlet configured to receive a flow of a liquid phase solvent from a solvent reservoir of the liquid chromatography system 300, an outlet 23 connected to the vacuum chamber 100, the outlet 23 configured to output a degassed flow of liquid solvent, and a temperature sensing device 30 for measuring a temperature of the vacuum chamber 100, wherein, when the temperature sensing device 30 detects a drop in temperature of the vacuum chamber 100, the liquid phase solvent is leaking into the interior region 27 of the vacuum chamber 100.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A method for detecting a fluid leak in a vacuum chamber, the method comprising:
measuring a temperature of the vacuum chamber with a temperature sensing device;
wherein a temperature drop of the vacuum chamber indicates the fluid leak within the vacuum chamber.

2. The method of claim 1, wherein the temperature drop is caused by a liquid phase of a solvent escaping into an interior region of the vacuum chamber under a vacuum.

3. The method of claim 2, wherein, when the liquid phase of the solvent enters the interior region of the vacuum chamber, the solvent is vaporized from the liquid phase by the vacuum within the vacuum chamber, which pulls heat from the interior region of the vacuum chamber and lowers the temperature of the vacuum chamber.

4. The method of claim 1, wherein the temperature of the vacuum chamber is measured by measuring a temperature of a wall of the vacuum chamber.

5. The method of claim 4, wherein the temperature sensing device is a contact temperature sensor attached to the wall of the vacuum chamber.

6. The method of claim 5, wherein the contact temperature sensor is attached to the wall of the vacuum chamber at an optimal measuring spot of the wall, the optimal measuring spot of the wall being more sensitive to heat transfer than a rest of the wall of the vacuum chamber.

7. The method of claim 6, wherein the optimal measuring spot of the wall of the vacuum chamber has a reduced wall thickness than a wall thickness of the rest of the wall of the vacuum chamber.

8. The method of claim 4, wherein the contact temperature sensor is at least one of: molded into the wall of the vacuum chamber, and disposed within an interior region of the vacuum chamber.

9. A method for identifying a vacuum chamber having a leak out of a plurality of vacuum chambers of a degasser within a liquid chromatography system, each vacuum chamber being connected to a same vacuum source, comprising:
measuring a temperature of a vacuum chamber wall of each vacuum chamber of the plurality of vacuum chambers using a plurality of temperature sensing devices;
detecting a change in temperature in the vacuum chamber wall of a single vacuum chamber of the plurality of vacuum chambers; and
identifying the single vacuum chamber with the temperature change in the vacuum chamber wall as the vacuum chamber having a leak.

10. The method of claim 9, further comprising: replacing the single vacuum chamber having the leak with a new vacuum chamber without replacing the other vacuum chambers of the plurality of vacuum chambers.

11. The method of claim 9, wherein, in response to the detecting, a temperature sensing device associated with the single vacuum chamber is configured to send an error message to a system controller of the liquid chromatography system that controls and monitors the plurality of vacuum chambers.

12. The method of claim 9, wherein the temperature change is a drop in temperature and pressure caused by a liquid phase of a solvent escaping into an interior region of the vacuum chamber under a vacuum; further wherein, when the liquid phase of the solvent enters the interior region of the vacuum chamber, the solvent is vaporized from the liquid phase by the vacuum within the vacuum chamber, which pulls heat from the interior region of the vacuum chamber and lowers the temperature of the vacuum chamber.

13. The method of claim 9, wherein the plurality of temperature sensing device are contact temperature sensors attached to the vacuum chamber wall of the plurality of vacuum chambers, further wherein the contact temperature sensors are attached to the vacuum chamber wall at a dedicated measuring spot of the vacuum chamber wall, the dedicated measuring spot of the vacuum chamber wall being more sensitive to heat transfer than a rest of the vacuum chamber wall of the vacuum chamber.

14. The method of claim 13, wherein the dedicated measuring spot of the vacuum chamber wall of the vacuum chamber has a reduced wall thickness than a wall thickness of the rest of the vacuum wall of the vacuum chamber.

15. A degasser of a liquid chromatography system, comprising:
a vacuum chamber having an interior region, the interior region being under a vacuum;
an inlet connected to the vacuum chamber, the inlet configured to receive a flow of a liquid phase solvent from a solvent reservoir of the liquid chromatography system;
an outlet connected to the vacuum chamber, the outlet configured to output a degassed flow of liquid solvent; and
a temperature sensing device for measuring a temperature of the vacuum chamber;
wherein, when the temperature sensing device detects a drop in temperature of the vacuum chamber, the liquid phase solvent is leaking into the interior region of the vacuum chamber.

16. The degasser of claim 15, wherein, when the liquid phase of the solvent leaks into the interior region of the vacuum, the solvent is vaporized from the liquid phase by the vacuum chamber within the vacuum, which pulls heat from the interior region of the vacuum chamber and lowers the temperature of the vacuum chamber.

17. The degasser of claim 15, wherein the temperature of the vacuum chamber is measured by measuring a temperature of a wall of the vacuum chamber.

18. The degasser of claim 17, wherein the temperature sensing device is a contact temperature sensor attached to the wall of the vacuum chamber.

19. The degasser of claim 18, wherein the contact temperature sensor is attached to the wall of the vacuum chamber at a dedicated measuring spot of the wall, the dedicated measuring spot of the wall being more sensitive to heat transfer than a rest of the wall of the vacuum chamber, further wherein the dedicated measuring spot of the wall of the vacuum chamber has a reduced wall thickness than a wall thickness of the rest of the wall of the vacuum chamber.

20. The degasser of claim 18, wherein the contact temperature sensor is at least one of: molded into the wall of the vacuum chamber, and disposed within an interior region of the vacuum chamber.
